(19) United States
(12) Patent Application Publication
(10) Pub. No.: US 2012/0106392 A1
(43) Pub. Date: May 3, 2012

(54) NETWORK RELAY DEVICE

(75) Inventor: Kaoru YANAGIBASHI, Nagoya-shi (JP)

(73) Assignee: Buffalo Inc., Nagoya-shi (JP)

(21) Appl. No.: 13/273,444

(22) Filed: Oct. 14, 2011

(30) Foreign Application Priority Data
Nov. 2, 2010 (JP) 2010-246219

(51) Int. Cl. H04L 12/56; H04L 12/26

(52) U.S. Cl. 370/253; 370/401; 370/392

(57) ABSTRACT

A network relay device includes an internal storage unit, an external storage unit having greater storage capacity than the internal storage unit, an accumulation control module and a relay processing module. The accumulation control module compares a receiving rate representative value representing a receiving rate with a sending rate representative value representing a sending rate and stores received data into the external storage unit having the greater storage capacity than the internal storage unit, when the receiving rate representative value is higher than the sending rate representative value. Even when the sending rate from the network relay device becomes a constrained condition of data relay, this prevents reception of data from a device, which sends data to the network relay device, from being constrained by the speed of the sender side.

### CROSS-REFERENCE TO RELATED APPLICATION

This application claims the priority based on Japanese Patent Application No. 2010-246219 filed on Nov. 2, 2010, the disclosure of which is hereby incorporated by reference in its entirety.

### BACKGROUND

### Related Art

Recently, with advance of ICT (Information and Communication Technology), digital contents such as moving pictures have been shared on the Internet. The user of the contents-sharing service not only obtains information from a server on the Internet (hereinafter called “download”) but occasionally sends information to the server (hereinafter called “upload”).

On widely used asymmetric Internet lines for domestic use, such as ADSL and VDSL, the line speed (outbound speed) for upload is set to be lower than the line speed (inbound speed) for download. When the user uploads information to the contents-sharing service on the Internet, the line speed becomes the rate-controlling factor (so-called “bottleneck”) and it takes a relatively long time for upload. During the upload, the device, such as computer, used for upload by the user consumes its resource for uploading operation. This causes the constraints on the use of the device, for example, the lowered response of the computer, during contents upload. According to a proposed technique, the network relay device relaying upload switches the detected upload traffic to a proxy server. The proxy server may substitute for the server on the Internet as the content upload destination, so as to free the device, such as computer, from the uploading operation within a short time.

In this case, it is required to introduce the proxy server to upload information by substituting for the device used by the user. Consequently, there is a need to minimize the constraints on the use of a device connected with the network relay device during data upload from the device.

### SUMMARY

According to one aspect of the invention, there is provided a network relay device comprising an internal storage unit and an external storage unit having greater storage capacity than the internal storage, wherein the network relay device stores received data into either the internal storage unit or the external storage unit and performs a data relay process. The network relay device comprises: an accumulation control module for storing data received by the network relay device into the external storage unit when a receiving rate representative value representing a receiving rate of data by the network relay device is higher than a sending rate representative value representing a sending rate of data from the network relay device, whilst storing the data received by the network relay device into the internal storage unit when the receiving rate representative value is not higher than the sending rate representative value; and a relay processing module for performing a relay process of data stored in the external storage unit and in the internal storage unit.

In the network relay device according to this aspect, when the receiving rate representative value is higher than the sending rate representative value, the accumulation control module stores the received data into the external storage unit having the greater storage capacity. Accordingly, it is not necessary to lower the receiving rate of data from a device, which uploads data by using the network relay device, to the sending rate of the network relay device. In other words, this prevents the line speed for data transmission after the network relay device from being the constraint on the use of the device. The device connected with the network relay device can thus send data to the network relay device, while avoiding possible backlog in data transmission. This results in eliminating at least part of the constraints on the use of the device connected with the network relay device.

The network relay device may further comprise a receiving rate calculation module for calculating at least one statistical value related to a data volume received per unit time by the network relay device, as the receiving rate representative value. Since the receiving rate representative value is calculated as at least one the statistical value related to the data volume received per unit time by the network relay device, this network relay device can quantitatively process the receiving rate representative value and adequately select the storage unit as the storage destination of the received data. Similarly the network relay device may further comprise a sending rate calculation module for calculating at least one statistical value related to a data volume sent per unit time from the network relay device, as the sending rate representative value. This network relay device can quantitatively process the sending rate representative value and thereby adequately select the storage unit as the storage destination of the received data.

The at least one the statistical value related to the data volume may be one of a mean value, a maximum value, a minimum value, a mode value and a median value. These values have clear statistical meanings and thus clearly define the meaning of the receiving rate representative value and the sending rate representative value.

In the network relay device, the receiving rate calculation module may continually measure a receiving rate indicating the data volume received per unit time, exclude a specific receiving rate having a temporal change over a reference level relative to at least one of a temporally last receiving rate and a temporally next receiving rate from the measured plural receiving rates, and calculate a mean value of the receiving rate as the receiving rate representative value. Similarly the sending rate calculation module may continually measure a sending rate indicating the data volume sent per unit time, exclude a specific sending rate having a temporal change over a reference level relative to at least one of a temporally last sending rate and a temporally next sending rate from the measured plural sending rates, and calculate a mean value of the sending rate as the sending rate representative value. In this network relay device, the receiving rate calculation module or the sending rate calculation module excludes the specific receiving rate or sending rate having the temporal change over the reference level from the continually measured plural receiving rates or sending rates and calculates the mean value of the receiving rate or the mean value of the sending rate as the receiving rate representative value or as the sending rate representative value, so that the receiving rate representative value and the sending rate representative value can be calculated without being affected by the occurrence of a fluctuation of communication rate caused by, for example, some disturbance.

In the network relay device, when sending plural data stored in the external storage unit, the relay processing module may perform the relay process by generating combination data such that consistency of contents of the plural data is maintained and sending the generated combination data. In this network relay device, the relay processing module generates the combination data by combining plural data stored in the external storage unit such that the consistency of the contents of the respective data is maintained, and performs the relay process of the combination data, so that this reduces the communication traffic on the line after the network relay device.

In the network relay device, the accumulation control module may identify whether a network address included in a destination address of data received by the network relay device is identical with a belonging network address of a network to which the network relay device belongs, and store the received data into the external storage unit based on determination that the receiving rate representative value is higher than the sending rate representative value when the network address included in the destination address is different from the belonging network address, whilst storing the received data into the internal storage unit based on determination that the receiving rate representative value is not higher than the sending rate representative value when the network address included in the destination address is identical with the belonging network address. In this network relay device, when the network address included in the destination address is different from the belonging network address, which may cause the performance of the line after the network relay device to be the bottleneck, the accumulation control module stores the received data into the external storage unit having the greater storage capacity. The device connected with the network relay device can thus continue sending data to the network relay device with avoiding possible backlog that may occur at some level of the sending rate. Accordingly, this eliminates at least part of the constraints on the use of the device connected with the network relay device.

According to another aspect of the invention, there is provided a network relay device, comprising: an internal storage unit; an external storage unit having greater storage capacity than the internal storage unit; an address identifying module; an accumulation control module; and a relay processing module. The address identifying module identifies whether a network address included in a destination address of data received by the network relay device is identical with a belonging network address of a network to which the network relay device belongs. The accumulation control module stores the data received by the network relay device into the external storage unit when the network address included in the destination address is different from the belonging network address, whilst storing the data received by the network relay device into the internal storage unit when the network address included in the destination address is identical with the belonging network address. The relay processing module performs a relay process of data stored in the external storage unit and in the internal storage unit. In this network relay device, when the network address included in the destination address is different from the belonging network address, which may cause the performance of the line after the network relay device to be the bottleneck, the accumulation control module stores the received data into the external storage unit having the greater storage capacity. The external device connected with the network relay device can thus continue sending data to the network relay device with avoiding possible backlog that may occur at some level of the sending rate. Accordingly, this eliminates at least part of the constraints on the use of the device connected with the network relay device.

The invention may be implemented by various other aspects. For example, the invention may be implemented, for example, as a method of relaying data from an internal network to an external network, a method of controlling a network relay device, a network system using a network relay device, a computer program for implementing the functions of any of these methods and devices, a storage medium for storing the computer program and a program product including the computer program and the storage medium.

### BRIEF DESCRIPTION OF THE DRAWINGS

FIG. 1 illustrates the general configuration of a wireless LAN system according to one embodiment of the invention;

FIG. 2 is a flowchart showing a processing flow performed by the controller of the router;

FIG. 3 illustrates the method of measuring the receiving rate and the sending rate;

FIG. 4 illustrates the method of calculating the mean value of the receiving rate and the mean value of the sending rate;

FIG. 5 is a graph corresponding to FIG. 4;

FIG. 6 is a sequence diagram showing the procedure of the ordinary relay process (step S20 of FIG. 2);

FIG. 7 is a sequence diagram showing the procedure of the accumulation relay process (step S22 of FIG. 2);

FIG. 8 shows the general configuration of a wireless LAN system according to the second embodiment;

FIG. 9 is a sequence diagram showing the procedure of the accumulation relay process according to the second embodiment;

FIG. 10 shows the general configuration of a wireless LAN system according to the third embodiment; and

FIG. 11 is a flowchart showing a processing flow performed by the controller of the router according to the third embodiment.

### DETAILED DESCRIPTION

The invention is described with reference to embodiments.

### A. First Embodiment

A1. General System Configuration

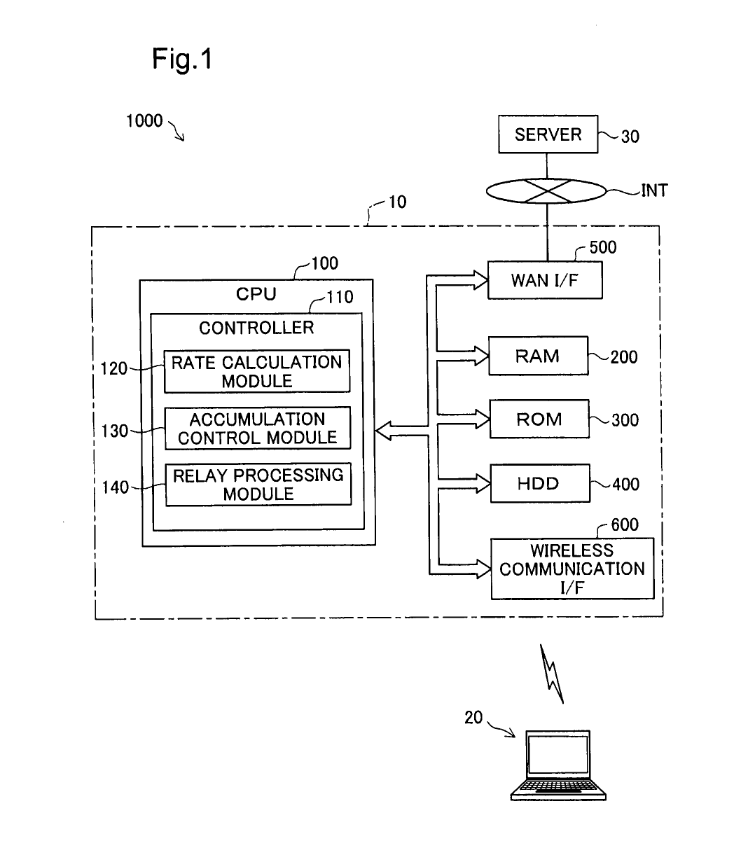

FIG. 1 illustrates the general configuration of a wireless LAN system 1000 according to one embodiment of the invention. The wireless LAN system 1000 includes a router 10, a personal computer (hereinafter also called “PC”) 20 and a server 30. The router 10 is a network relay device conforming to the IEEE802.11 standard. The router 10 has a wired connection to the server 30 via the Internet INT, while having a wireless connection to the PC 20. The PC 20 has the setting of the same ESSID (Extended Service Set Identifier) as that of the router 10 and the setting of wireless encryption. Although only one PC 20 is connected to the router 10 in the illustrated example in the embodiment, two or more PCs may be connected to the router 10. The server 30 is a server computer for providing the PC 10 with specified services (for example, WEB services).

The router 10 includes a CPU 100, a RAM 200 as the internal storage unit, a ROM 300, a hard disk drive (hereinafter also called “HDD”) 400 as the external storage unit, a WAN interface (I/F) 500 and a wireless communication interface (I/F) 600, which are interconnected by bus.

The CPU 100 loads and executes a program stored in the HDD 400 on the RAM 200, so as to control the respective parts of the router 10. The CPU 100 also includes a controller 110. The controller 110 functions as an accumulation control module 130 and a relay processing module 140. In this embodiment, the control module 110 also functions as a receiving/sending rate calculation module (hereinafter collectively called “rate calculation module 120”). The rate calculation module 120 has the function of measuring the receiving rate indicating the data volume received by the router 10 in a unit time and the sending rate indicating the data volume sent from the router 10 in a unit time. Additionally, the rate calculation module 120 has the function of calculating the mean value from the measured receiving rate and sending rate. The accumulation control module 130 has the function of storing the data received by the router 10 into the RAM 200 or the HDD 400. The relay processing module 140 has the function of relaying the data stored by the accumulation control module 130. The details of these functions of respective parts will be described later.

The WAN interface 500 is an interface for the lines on the Internet INT. The wireless communication interface 600 is an interface for wireless communication with the PC 20.

A2. Processing by Controller

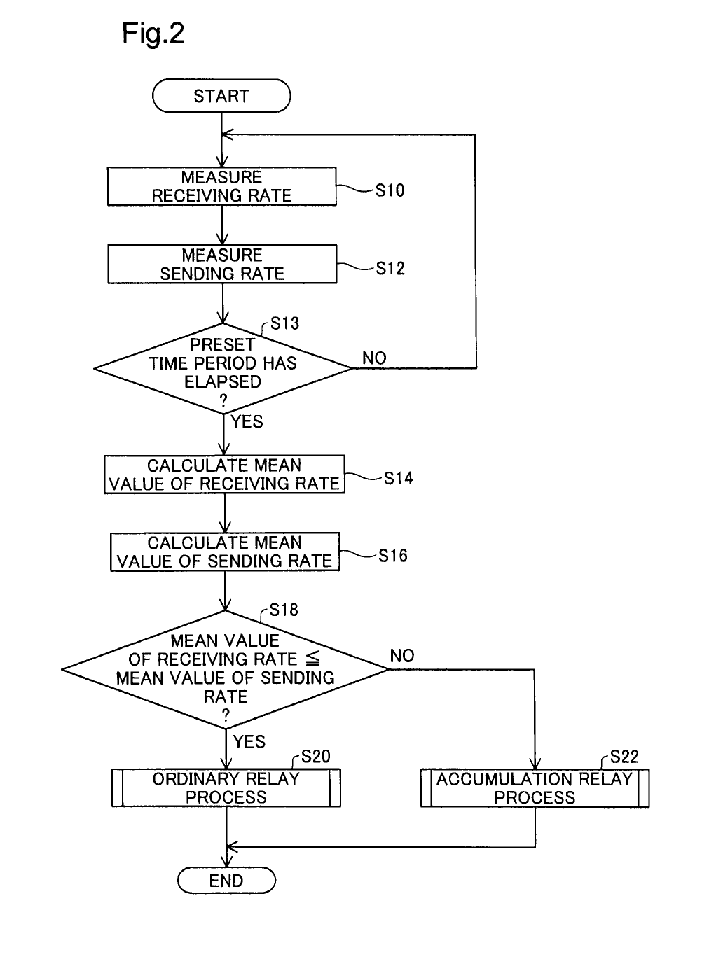

FIG. 2 is a flowchart showing a processing flow performed by the controller 110 of the router 10. The controller 110 of the router 10 repeatedly performs the processing flow of FIG. 2 at preset time intervals (for example, at every one second). The controller 110 measures the receiving rate indicating the data volume received by the router 10 in a unit time and the sending rate indicating the data volume sent from the router 10 in a unit time (steps S10 and S12). This process corresponds to the operation of the rate calculation module 120.

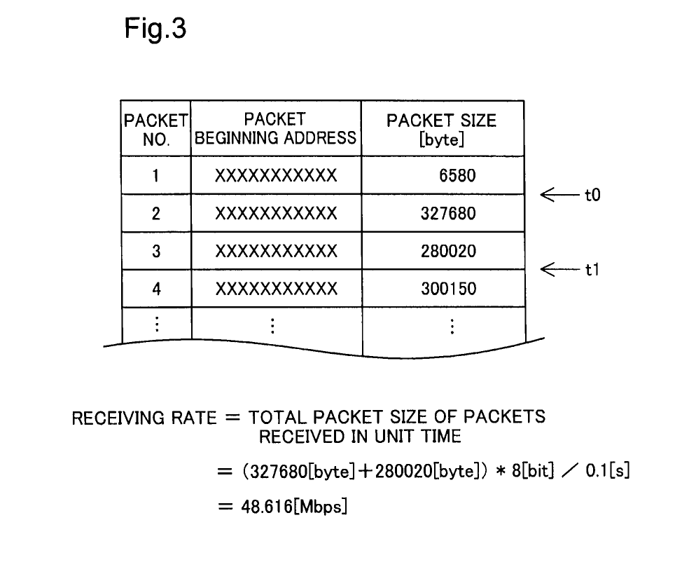

FIG. 3 illustrates the method of measuring the receiving rate and the sending rate. FIG. 3 shows one example of packet number, packet beginning address and packet size with respect to each of the packets received by the router 10. The packet number is an identifier unequivocally assigned in the order of receiving the packets by the router 10. The packet beginning address is the address included in the beginning part of the header of the received packet. The packet size is the size (byte) of the received packet. These data are stored in the form of FIG. 3 in a specific area of the RAM 200 by a discrete processing routine performed by the CPU 100, every time the WANI/F receives a packet.

The rate calculation module 120 sets the total packet size of the packets received in a unit time to the receiving rate (Mbps). For example, when t0 represents a start time of rate measurement and t1 represents a time after the elapse of a unit time (e.g., 100 milliseconds) from the start time t0, the rate calculation module 120 calculates the total packet size of a packet with packet number 2 and a packet with packet number 3 received between the time t0 and the time t1. According to the example of FIG. 3, the rate calculation module 120 sums up the packet size (327680 bytes) of the packet with packet number 2 and the packet size (280020 bytes) of the packet with packet number 3 and sets the value 48 (Mbps) obtained by the unit conversion to the receiving rate. Although the unit time is set to 100 milliseconds (=0.1 second) in the above example, the unit time may be set arbitrarily. Although the method of measuring the receiving rate has been described above as an example, the method of measuring the sending rate is performed similarly.

At step S13 of FIG. 2, the rate calculation module 120 checks whether a preset time period has elapsed since the start time t0, when the measurement of the receiving rate and the sending rate started. The preset time may be any arbitrary time, for example, 1 second. After the elapse of the preset time period, the rate calculation module 120 calculates the mean value of the receiving rate and the mean value of the sending rate (steps S14 and S16). The processing flow of FIG. 2 is performed at every one second, and data are accumulated in the table of FIG. 3 every time a packet is received or sent. Accordingly, the processing flow adds up the received packets and the sent packets in each unit time (0.1 second) at steps S10 and S12 among those accumulated in the preset time period of 1 second and immediately proceeds to the process of calculating the respective mean values (steps S14 and S16). The processing flow waits for elapse of the preset time period (1 second in this example), in order to ensure that measuring the receiving rate (step S10) and measuring the sending rate (step S12) have been performed multiple times.

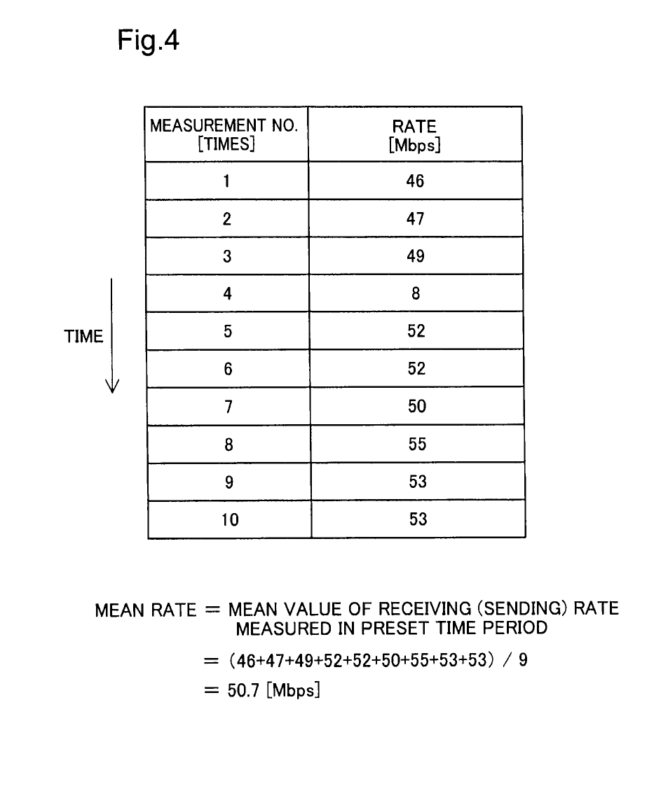

FIG. 4 illustrates the method of calculating the mean value of the receiving rate and the mean value of the sending rate. In FIG. 4, an example of plural receiving rates (Mbps) measured by the rate calculation module 120 repeating the process of step S10 of FIG. 2 in the preset time period (i.e., 1 second) is shown. The measurement number shows the number of times when the measurement of the receiving rate (step S10 of FIG. 2) has been performed. The rate shows the receiving rate (Mbps) obtained as the measurement result of the receiving rate.

The rate calculation module 120 excludes any specific receiving rate having temporal changes over a reference level relative to both a temporally last receiving rate and a temporally next receiving rate from the plural receiving rates measured in the preset time period and calculates the mean value after such exclusion as the mean rate (Mbps). The following describes a concrete example using the reference level of 20%. The rate calculation module 120 checks the temporal changes of each receiving rate relative to the temporally last receiving rate and the temporally next receiving rate with respect to all the receiving rates of the measurement times 1 to 10. More specifically, it is checked whether there is any receiving rate measured at the N-th time having temporal changes over ±20% relative to the receiving rate measured at the (N−1)-th time and relative to the receiving rate measured at the (N+1)-th time (such receiving rate is called “exclusion object data”). According to the example of FIG. 4, the receiving rate (8 Mbps) measured at the fourth time (between times t3 and t4) has temporal changes over 20% relative to both the receiving rate of 49 Mbps measured at the third time and the receiving rate of 52 Mbps measured at the fifth time and is thereby specified as exclusion object data. Alternatively, the exclusion object data may be specified by only a temporal change relative to either the last measurement data or the next measurement data.

After the above check has been performed for all the receiving rates measured in the preset time period, the rate calculation module 120 calculates the mean value of all the receiving rates other than the exclusion object data. More specifically, the rate calculation module 120 adds up the receiving rates of the measurement times 1 to 3 and 5 to 10 other than the receiving rate of the measurement time 4 specified as the exclusion object data, divides the result of the addition by the number of the added data and sets the result of the division to the mean value of the receiving rate (Mbps). The reference level is set to 20% in the above example but may be determined arbitrarily. Additionally, although the method of calculating the mean value of the receiving rate has been described above as an example, the method of calculating the mean value of the sending rate is performed similarly.

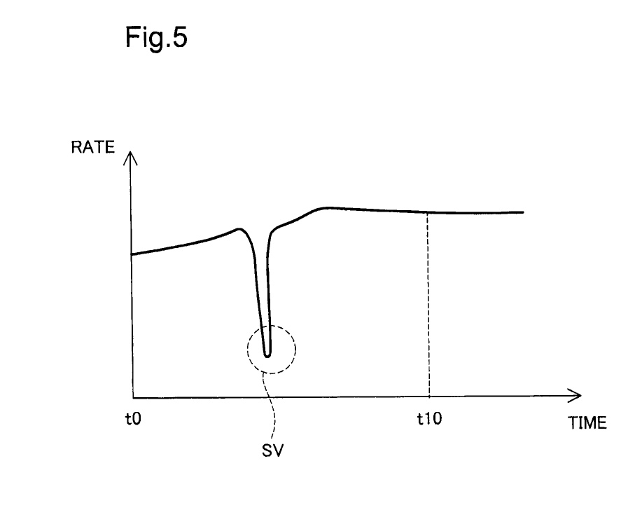

FIG. 5 is a graph corresponding to FIG. 4. The rate calculation module 120 excludes the data (exclusion object data) having the temporal changes over the reference level relative to both the temporally last receiving rate and the temporally next receiving rate, when calculating the mean value of the receiving rate (or the sending rate) as described above. Even when there is a fluctuation SV of communication rate in the router 10 caused by, for example, some disturbance, the rate calculation module 120 can obtain the accurate mean value non-susceptible to the fluctuation by excluding the data with the fluctuation SV. Although the advantageous effect on the occurrence of a rate-decreasing fluctuation has been described with reference to FIGS. 4 and 5, the similar effect is ensured on the occurrence of a rate-increasing fluctuation.

The mean value of the receiving rate and the mean value of the sending rate thus calculated respectively correspond to the receiving rate representative value representing the receiving rate and the sending rate representative value representing the sending rate. After calculating these values, the controller 110 compares the mean value of the receiving rate calculated at step S14 with the mean value of the sending rate calculated at step S16 (step S18). When the mean value of the receiving rate is equal to or lower than the mean value of the sending rate (step S18: Yes), the controller 110 performs an ordinary relay process (step S20). When the mean value of the receiving rate is higher than the mean value of the sending rate (step S18: No), on the other hand, the controller 110 performs an accumulation relay process (step S22). The details of these processes are described below.

A3. Ordinary Relay Process

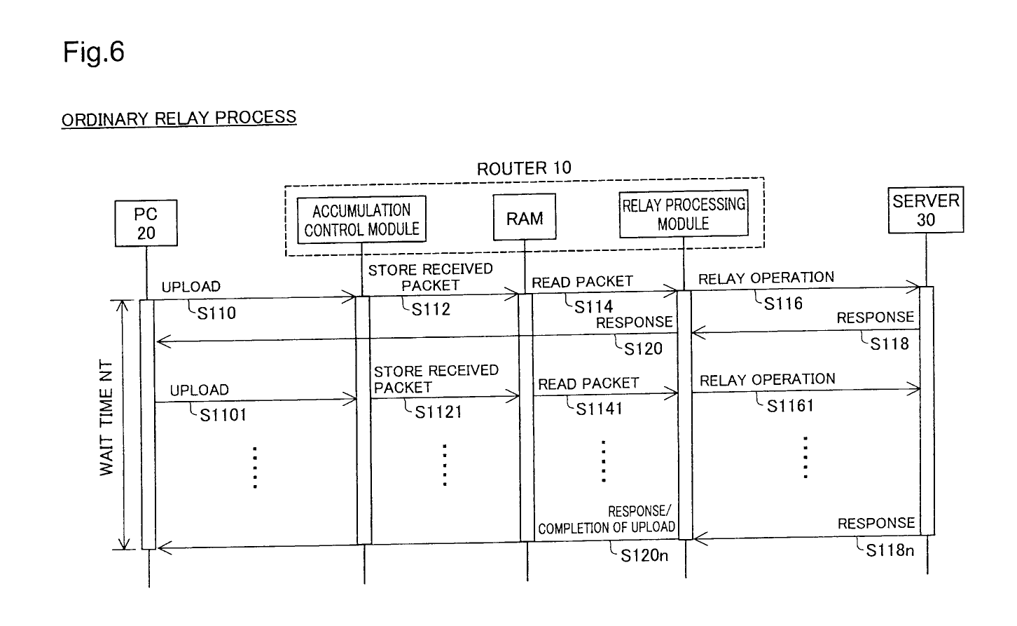

FIG. 6 is a sequence diagram showing the procedure of the ordinary relay process (step S20 of FIG. 2). The PC 20 starts data upload to the router 10 (step S110). The router 10 receives upload data (packet) sent from the PC 20 via the wireless communication interface 600. The accumulation control module 130 stores the received packet in its original form including a header portion and a payload portion into the RAM 200 as the internal storage unit (step S112). The relay processing module 140 reads the packet stored in the RAM 200 (step S114). The relay processing module 140 then performs relay operation of the read packet (e.g., routing, filtering and queuing) (step S116). As described previously, at the time of receiving the packet, the table of FIG. 3 used for measuring the receiving rate is also stored in the specific area of the RAM 200.

The server 30 receiving the packet relayed by the relay processing module 140 sends a response packet to the router 10 (step S118). On completion of transmission of one packet, the server 30 sends a response packet, and the relay processing module 140 receives the response packet via the WAN interface 500. At this moment, as in the case of receiving the packet from the PC 20, a table used for measuring the sending rate is stored in the specific area of the RAM 200. The relay processing module 140 receiving the response packet from the server 30 sends this response packet to the PC 20 (step S120). The PC 20 receiving the response packet from the relay processing module 140 sends further upload data (packet) to the router 10 (step S101). The router 10 relays the received packet according to the same procedure as described above (steps S1121 to S1161).

The ordinary relay process in the wireless LAN system 1000 repeats the same series of processing (steps S1101 to S1161 in FIG. 6) as the processing of steps S110 to S120 to implement data upload from the PC 20 to the server 30. An upload wait time NT of the PC 20 in the ordinary relay process is a time period from the start of data upload (step S110) to reception of a response packet responding to a last-sent packet (step S120n). In the meantime, the received packets are stored in the RAM 200 and are read from the RAM 200. When transmission of all the packets is completed and the response packet corresponding to the last-sent packet is sent back from the server 30, the packets stored in the RAM 200 are deleted to free the relevant area of the RAM 200.

A4. Accumulation Relay Process

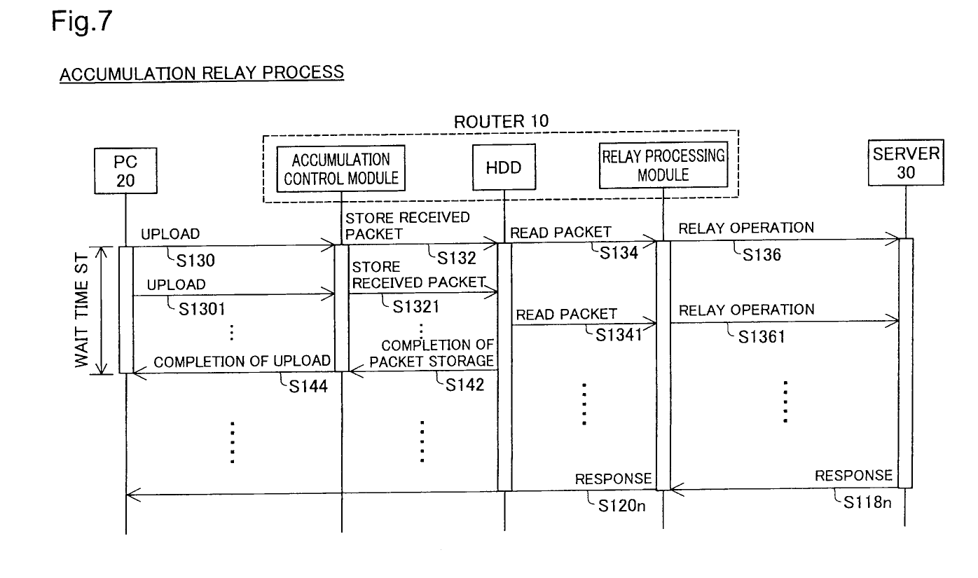

FIG. 7 is a sequence diagram showing the procedure of the accumulation relay process (step S22 of FIG. 2). The PC 20 starts data upload to the router 10 (step S130). The router 10 receives upload data (packet) sent from the PC 20 via the wireless communication interface 600. The accumulation control module 130 stores the received packet in its original form including a header portion and a payload portion into the HDD 400 as the external storage unit (step S132). The tables used for measuring the receiving rate and the sending rate (FIG. 3) are stored in the RAM 200 in the same manner as the ordinary relay process.

The accumulation relay process repeats the same series of processing (steps S1301 and S1321 in FIG. 7) as the processing of steps S130 and S132. More specifically, every time a packet is received from the PC 20, the accumulation control module 130 stores the received packet into the HDD 400. This series of processing continues until completion of transmission of the upload data from the PC 20. After all the packets sent from the PC 20 have been stored in the HDD 400, the accumulation control module 130 sends a response indicating completion of upload to the PC 20 (steps S142 and S144). An upload wait time ST of the PC 20 in the accumulation relay process is accordingly a time period from the start of da upload (step S130 to reception of the response indicating completion of upload (step S144).

The relay processing module 140 reads one of the packets stored in the HDD 400 (step S134) and performs relay operation of the read packet (step S136). The server 30 receiving the packet relayed by the relay processing module 140 sends a response packet to the router 10. The relay processing module 140 of the router 10 receiving the response packet from the server 30 sends the response packet to the PC 20. For clarity of illustration, the steps of sending the response packet are omitted from the illustration. The relay processing module 140 repeats reading one of the packets stored in the HDD 400 and performing the relay operation (step S1341 and S1361) until no packet remains in the storage of the HDD 400.

As described above, in the network relay device of the first embodiment (router 10), the accumulation control module 130 performs the accumulation relay process (step S22) when the mean value of the receiving rate is higher than the mean value of the sending rate (FIG. 2, step S18: No). More specifically, as shown in FIG. 7, the accumulation control module 130 stores the received data into the HDD 400 as the external storage unit, and the relay processing module 140 performs the relay process of the data stored in the HDD 400. When the mean value of the receiving rate is equal to or lower than the mean value of the sending rate (FIG. 2, step S18: Yes), on the other hand, the accumulation control module 130 performs the ordinary relay process (step S20). More specifically, as shown in FIG. 6, the accumulation control module 130 stores the received data into the RAM 200 as the internal storage unit, and the relay processing module 140 performs the relay process of the data stored in the RAM 200.

The accumulation relay process shown in FIG. 7 performs the process of storing all the received data from the device (PC 20) into the HDD 400 having the greater storage capacity than the RAM 200, in parallel with the relay process of received data by the relay processing module 140. The data stored in the HDD 400 are successively relayed by the relay processing module 140. This avoids the presence of bottleneck for the PC 20, even when the mean value of the receiving rate of the router 10 is higher than the mean value of the sending rate, which may cause the line performance after the router 10 to be the bottleneck. In other words, the PC 20 connected with the router 10 does not depend on the line speed after the router 10 but can continue and complete data transmission to the router 10 with avoiding the possible backlog that may occur at some level of the sending rate.

This results in shortening the data communication time of the PC 20 connected to the router 10. Shortening the data communication time means shortening the resource consumption time of the PC 20 for communication. Accordingly, the first embodiment described above eases the constraints on the use of the PC 20 during data upload.

### B. Second Embodiment

According to a second embodiment of the invention, the processing flow of the accumulation relay process different from that performed by the network relay device of the first embodiment is described. The following describes only the different configuration and operations from those of the first embodiment. The like elements to those of the above first embodiment are expressed by the like numerals or symbols and are not specifically described here.

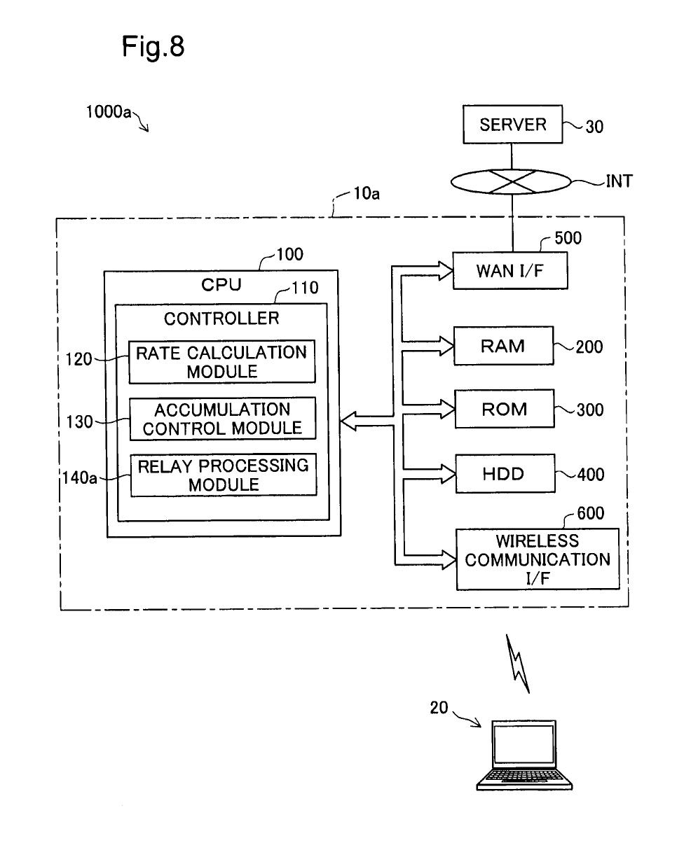

FIG. 8 shows the general configuration of a wireless LAN system according to the second embodiment. The difference from the first embodiment shown in FIG. 1 is only that a router 10a includes a relay processing module 140a, in place of the relay processing module 140 of the router 10, and otherwise the configuration and the operations are identical with those of the first embodiment. The relay processing module 140a has the function of performing relay processes of data stored by the accumulation control module 130. The ordinary relay process of the relay processes performed by the relay processing module 140a is identical with that of the first embodiment shown in FIG. 6.

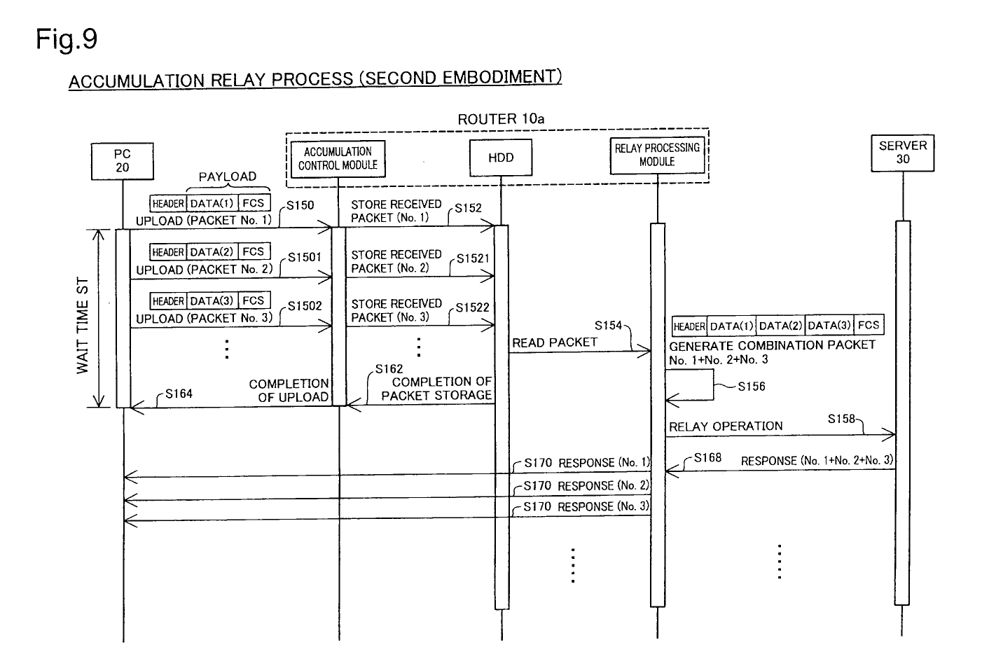

FIG. 9 is a sequence diagram showing the procedure of the accumulation relay process according to the second embodiment. This accumulation relay process is series of processing corresponding to step S22 of FIG. 2. The PC 20 starts data upload to the router 10 (step S150). A packet sent from the PC 20 to the router 10 as upload data includes a header portion and a payload portion as illustrated in FIG. 9 (such illustration is omitted in the first embodiment). The payload portion includes a data body to be transferred and an FCS (Frame Check Sequence) for error detection. The accumulation control module 130 receiving the packet sent from the PC 20 stores the received packet in its original form including the header portion and the payload portion into the HDD 400 (step S152).

The accumulation relay process of the second embodiment repeats the same series of processing (steps S1501, S1521, S1502 and S1522) as the processing of steps S150 and S152. More specifically, every time a packet is received from the PC 20, the accumulation control module 130 stores the received packet into the HDD 400. This series of processing continues until completion of transmission of the upload data from the PC 20. After all the packets sent from the PC 20 have been stored in the HDD 400, the accumulation control module 130 sends a response indicating completion of upload to the PC 20 (steps S162 and S164).

When detecting storage of plural packets in the HDD 400, the relay processing module 140a reads a preset number of packets (for example, three) from the HDD 400 (step S154). The number of packets read by the relay processing module 140a may be set arbitrarily. The relay processing module 140a generates a combination packet (also called “combination data”) generated by combining the read plural packets such that the consistency of the contents of the respective data is maintained (step S156). For example, the relay processing module 140a generates a combination packet including (i) header portion of one arbitrary packet; (ii) combined data body; and (iii) FCS. The combined data body is generated by combining the data bodies of all the read packets based on the sequence numbers included in the respective header portions, such that the continuity of the combined data body is ensured. The FCS is newly generated according to the combined data body.

For example, when packets of packet Nos. 1, 2 and 3 respectively have sequence numbers 1, 2 and 3, the relay processing module 140a generates the respective data parts as:

(i) header portion of the packet No. 1;

(ii) combined data body including data (1) of the packet No. 1 having the sequence number 1, data (2) of the packet No. 2 having the sequence number 2 and data (3) of the packet No. 3 having the sequence number 3; and

(iii) FCS newly generated according to the combined data body (1)+(2)+(3).

The relay processing module 140a generates a packet including the respective data parts (i) to (iii) in this order.

Subsequently the relay processing module 140a performs relay operation of the generated combination packet (step S158). The server 30 receiving the packet relayed by the relay processing module 140a sends a response packet to the router 10 (step S168). The relay processing module 140a of the router 10 receiving the response packet from the server 30 sends the response packet to the PC 20 (step S170). It is desirable that the response packet sent by the relay processing module 140a at step S170 is sent individually for each of the plural combined packets. This enables the PC 20 to perform the series of processing without specifically concerning about the combination of packets in the router 10. The relay processing module 140a repeats reading the preset number of packets from the storage of the HDD 400 (step S154), generating a combination packet (step S156) and performing the relay operation (step S158) until no packet remains in the storage of the HDD 400.

As described above, the network relay device of the second embodiment (router 10a) has the similar advantageous effects to those of the first embodiment and additionally has the following functions and effects. More specifically, the relay processing module 140a generates combination data (combination packet) by combining plural data (packets) read from the storage of the HDD 400 as the external storage unit such that the consistency of the respective data is maintained and performs relay operation of the combination data. Accordingly, this reduces the communication traffic on the line after the network relay device.

The first embodiment and the second embodiment described above uses the mean value of the receiving rate and the mean value of the sending rate as the receiving rate representative value and the sending rate representative value, makes their comparison and performs the relay process with changing the storage destination of the data (packets) based on the result of the comparison. The receiving rate representative value and the sending rate representative value are, however, not limited to such mean values but may be other statistical values, such as maximum values, minimum values, mode values or median values. The first embodiment excludes the receiving rate or the sending rate per unit time having significant temporal changes relative to both the temporally last data and the temporally next data, from the calculation of the mean value, but a simple mean value without such exclusion may be used as the representative value. Instead of using these statistical values, a modified procedure may measure the receiving rate and the sending rate at a specific moment, for example, at the moment of sending a first packet of data to be uploaded, and compares the measured rates to determine the relay process to be performed.

### C. Third Embodiment

According to a third embodiment of the invention, the processing flow different from that performed by the controller in the network relay device of the first embodiment is described. The following describes only the different configuration and operations from those of the first embodiment. The like elements to those of the above first embodiment are expressed by the like numerals or symbols and are not specifically described here.

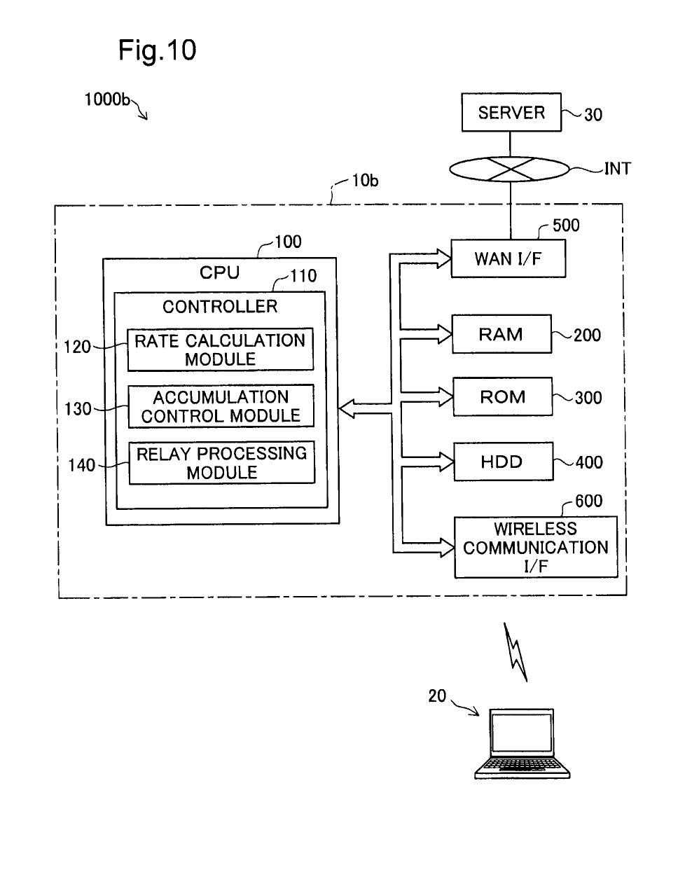

FIG. 10 shows the general configuration of a wireless LAN system according to the third embodiment. The difference from the first embodiment shown in FIG. 1 is only that a router 10b includes an address identifying module 150, in place of the rate calculation module 120 of the router 10, and otherwise the configuration and the operations are identical with those of the first embodiment. The address identifying module 150 identifies whether a network address included in a destination address of received data is identical with the network address of the network to which the router 10b belongs.

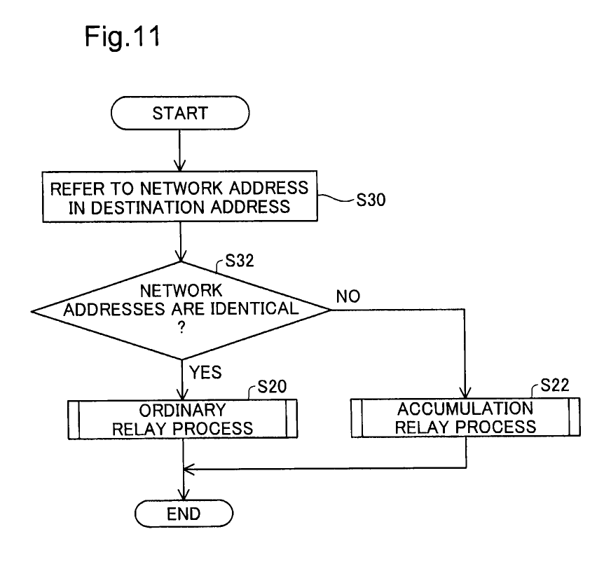

FIG. 11 is a flowchart showing a processing flow performed by the controller 110 of the router 10b according to the third embodiment. The controller 110 of the router 10b repeatedly performs the processing flow of FIG. 11 at preset time intervals (for example, at every one second). The difference from the first embodiment shown in FIG. 2 is only steps S30 and S32 to be performed in place of steps S10 to S18, and otherwise the configuration and the operations are identical with those of the first embodiment.

The address identifying module 150 of the controller 110 refers to a destination IP address included in a header portion of data (packet) received by the router 10b and refers to a network address included in the destination IP address (step S30). The address identifying module 150 subsequently identifies whether the network address included in the destination IP address is identical with the network address of the network to which the router 10b belongs (step S32). When the network address included in the destination IP address is identical with the network address of the network to which the router 10b belongs (step S32: Yes), the controller 110 performs ordinary relay process (step S20). The details of the ordinary relay process are identical with those of the first embodiment described with reference to FIG. 6. When the network address included in the destination IP address is not identical with the network address of the network to which the router 10b belongs (step S32: No), on the other hand, the controller 110 performs accumulation relay process (step S22). The details of the accumulation relay process are identical with those of the first embodiment described with reference to FIG. 7.

As described above, the network relay device of the third embodiment (router 10b) performs the ordinary relay process, when the data (packet) received by the router 10b is a packet addressed to the network to which the router 10b belongs. The router 10b performs the accumulation relay process, on the other hand, when the packet received by the router 10b is a packet addressed to outside of the network to which the router 10b belongs. This is because the relay process to an external network to which the router 10b does not belong generally has the lower sending rate and takes more time for packet transmission according to, for example, the performance of the line, compared with the relay process to the internal network to which the router 10b belongs. The third embodiment estimates the difference in communication rate based on the network address without actually measuring and calculating the receiving rate representative value and the sending rate representative value, thereby ensuring the similar effects to those of the first embodiment.

### D. Modifications

The invention is not limited to the above embodiments or applications discussed above but various modifications may be made to the embodiments without departing from the scope of the invention. For example, the functions implemented by the software configuration may be implemented by the hardware configuration. Some of other possible modifications are given below.

### D1. Modified Example 1

In the above embodiment, the configuration of the wireless LAN system has been described. The configuration of the wireless LAN system in the above embodiment is, however, only illustrative and may be modified in various ways. Available modifications may include omission of part of the components of the wireless LAN system, addition of further components to the wireless LAN system and modification of part of the components of the wireless LAN system.

For example, the router of the above embodiment is the wireless router including the wireless communication interface and conforming to the IEEE802.11 standard to relay packets based on IP addresses. The router may, however, be a layer 3 switch that is capable of relaying frames based on MAC addresses, in addition to relaying packets based on IP addresses. The router may also be a network relay device for a wired LAN that is capable of relaying data between an internal network and an external network.

Although the accumulation relay process performed by the router of the above embodiment stores received data (packets) into the HDD, the received data may be stored in any other storage medium, such as a flash ROM or SSD (Solid State Drive), which is usable as an external storage unit having the greater storage capacity than the internal storage unit.

In the router of the above embodiment, the CPU has been described to have the controller including the rate calculation module or the address identifying module, the accumulation control module and the relay processing module. The functions performed by the respective modules have also been described in the above embodiment. The configuration of the respective modules and the functions performed by the respective modules are, however, only illustrative and may be modified arbitrarily according to the structure of the router.

For example, the functions of the relay processing module described in the above embodiment may be implemented by a physical chip constituting a WAN interface or a wireless communication interface. The functions of the remaining modules other than the relay processing module may be implemented by the CPU.

### D2. Modified Example 2

The above embodiment (FIG. 2) describes the exemplary processing flow performed by the controller of the router. The series of processing performed by the control of the router may, however, be modified in various ways.

The series of processing described with FIG. 2 is repeatedly performed at preset time intervals (for example, at every one second). The execution timing of the processing may, however, be set arbitrarily. For example, the processing may be performed only once at the time of initial setting of the router or may be performed manually by the user (for example, command input or selection of an option from a menu).

The sequence of the ordinary relay process described with reference to FIG. 6 or the accumulation relay process described with reference to FIG. 7 may be modified in various ways, for example, changing the execution order in the sequence, omitting part of the sequence, or integrating plural sequences.

### D3. Modified Example 3

The second embodiment (FIG. 9) describes the exemplary flow of the combination packet generating process performed by the relay processing module. The combination packet generating process may, however, be modified in vary ways.

In the above embodiment, when detecting storage of plural packets in the HDD, the relay processing module reads a preset number of packets from the storage and generates a combination packet from the read packets. Another condition, for example, at a preset time, may trigger the combination packet generating process. When the combination packet generating process is triggered at the preset time, the number of packets as the combining object may be indefinite (for example, all the packets stored in the HDD at the time of reading packets).

While the invention has been described with the embodiments of the invention, among the various elements of the invention included in the above embodiments, those other than the elements disclosed in independent claims are additional and supplementary elements and may be omitted or combined according to the requirements. Additionally, the invention is not limited to the above embodiment but may be implemented in diversity of other embodiments and applications within the scope of the invention. For example, the invention may be implemented by a program of network relay method and a storage medium in which the program is recorded, in addition to the network relay device and the network relay method.

1. A network relay device, comprising:
an internal storage unit;
an external storage unit having greater storage capacity than the internal storage unit;
an accumulation control module that stores data received by the network relay device into the external storage unit when a receiving rate representative value representing a receiving rate of data by the network relay device is higher than a sending rate representative value representing a sending rate of data from the network relay device, and stores the data received by the network relay device into the internal storage unit when the receiving rate representative value is not higher than the sending rate representative value; and
a relay processing module that performs a relay process of data stored in the external storage unit and in the internal storage unit.

2. The network relay device according to claim 1, further comprising:
a receiving rate calculation module that calculates at least one statistical value related to a data volume received per unit time by the network relay device as the receiving rate representative value.

3. The network relay device according to claim 1, further comprising:
a sending rate calculation module that calculates at least one statistical value related to a data volume sent per unit time from the network relay device as the sending rate representative value.

4. The network relay device according to claim 2, wherein
the at least one statistical value related to the data volume is one of a mean value, a maximum value, a minimum value, a mode value and a median value.

5. The network relay device according to claim 2, wherein the receiving rate calculation module continually measures plural receiving rates indicating the data volume received per unit time, excludes a specific receiving rate having a temporal change over a reference level relative to at least one of a temporally last receiving rate and a temporally next receiving rate from the measured plural receiving rates, and calculates a mean value of the measured plural receiving rates from which the specific receiving rate is excluded as the receiving rate representative value.

6. The network relay device according to claim 3, wherein
the sending rate calculation module continually measures plural sending rates indicating the data volume sent per unit time, excludes a specific sending rate having a temporal change over a reference level relative to at least one of a temporally last sending rate and a temporally next sending rate from the measured plural sending rates, and calculates a mean value of the measured plural sending rates from which the specific sending rate is excluded as the sending rate representative value.

7. The network relay device according to claim 1, wherein
when sending plural data stored in the external storage unit, the relay processing module performs the relay process by generating combination data such that consistency of contents of the plural data is maintained.

8. The network relay device according to claim 1, wherein
the accumulation control module identifies whether a network address included in a destination address of data received by the network relay device is identical to a belonging network address of a network to which the network relay device belongs, and stores the received data into the external storage unit based on a determination that the receiving rate representative value is higher than the sending rate representative value when the network address included in the destination address is different from the belonging network address, and stores the received data into the internal storage unit based on a determination that the receiving rate representative value is not higher than the sending rate representative value when the network address included in the destination address is identical to the belonging network address.

9. A method of relaying data to be sent from an internal network to an external network, comprising:
storing received data into an internal storage unit when a receiving rate representative value representing a receiving rate of data from the internal network is not higher than a sending rate representative value representing a sending rate of data to the external network, and storing the received data into an external storage unit having greater storage capacity than the internal storage unit when the receiving rate representative value is higher than the sending rate representative value; and
performing a relay process of data stored in the external storage unit and in the internal storage unit.

10. A method of controlling a network relay device comprising an internal storage unit and an external storage unit having greater storage capacity than the internal storage unit, comprising:
storing data received by the network relay device into the external storage unit when a receiving rate representative value representing a receiving rate of data by the network relay device is higher than a sending rate representative value representing a sending rate of data from the network relay device, and storing the data received by the network relay device into the internal storage unit when the receiving rate representative value is not higher than the sending rate representative value; and
performing a relay process of data stored in the external storage unit and in the internal storage unit.

11. A computer-readable medium including a computer program, which when executed by a network relay device, causes the network relay device to perform a method comprising:
storing data received by the network relay device into an internal storage unit when a receiving rate representative value representing a receiving rate of data by the network relay device is not higher than a sending rate representative value representing a sending rate of data from the network relay device, and storing the data received by the network relay device into an external storage unit having larger storage capacity than the internal storage unit when the receiving rate representative value is higher than the sending rate representative value; and
performing a relay process of data stored in the external storage unit and in the internal storage unit.

12. A network relay device, comprising:
an internal storage unit;
an external storage unit having greater storage capacity than the internal storage unit;
an address identifying module that identifies whether a network address included in a destination address of data received by the network relay device is identical to a belonging network address of a network to which the network relay device belongs;
an accumulation control module that stores the data received by the network relay device into the external storage unit when the network address included in the destination address is different from the belonging network address, and stores the data received by the network relay device into the internal storage unit when the network address included in the destination address is identical to the belonging network address; and
a relay processing module that performs a relay process of data stored in the external storage unit and in the internal storage unit.
